(19) United States
(12) Patent Application Publication
(10) Pub. No.: US 2011/0260671 A1
(43) Pub. Date: Oct. 27, 2011

(54) APPARATUS FOR SELECTING SPEED OF ELECTRICALLY COMMUTATED MOTOR FOR USE IN HVAC SYSTEM

(75) Inventor: Young Chun Jeung, Cypress, CA (US)

(73) Assignee: SNTECH, INC., Phoenix, AZ (US)

(21) Appl. No.: 13/092,505

(22) Filed: Apr. 22, 2011

Related U.S. Application Data
(60) Provisional application No. 61/327,038, filed on Apr. 22, 2010.

(51) Int. Cl. H02P 6/08; B23P 17/00

(52) U.S. Cl. 318/701; 318/503; 29/402.08

(57) ABSTRACT

A DC motor system includes a plurality of speed taps coupled to an AC source and a variable speed DC motor. A circuit determines which speed taps are coupled to the AC source, outputs corresponding logic signals, and isolates digital circuits from the AC source. A digital logic device accesses from memory a value corresponding to the upper limit speed of the variable speed DC motor, determines a commanded motor speed based at least in part on the logic signals and the upper limit speed value, and outputs a pulse width modulated signal having a duty cycle corresponding to the determined commanded motor speed. A driver receives the pulse width modulated signal and outputs a corresponding signal. The variable speed DC motor receives the driver output signal, and rotates a rotor at a speed corresponding to the pulse width modulated signal duty cycle.

### CROSS-REFERENCE TO RELATED APPLICATIONS

This application claims the benefit under 35 U.S.C. 119(e) of U.S. Provisional Application No. 61/327,038, filed Apr. 22, 2010, the content of which is incorporated herein by reference in its entirety.

### BACKGROUND OF THE INVENTION

1. Field of the Invention

The present disclosure relates to selecting the speed of a motor, such as a DC motor.

2. Description of the Related Art

Many conventional HVACR (Heating, Ventilating, Air Conditioning, and Refrigeration) systems include variable speed AC motors to control airflow and for use with condensers. Conventionally, such AC motors utilize high voltage terminals to provide for motor speed selection.

### SUMMARY OF THE INVENTION

Described herein are embodiments for controlling the speed of a motor, such as a DC motor (e.g., an ECM (Electronically Commutated Motor)).

Optionally, certain embodiments enable a DC motor system to be used as a drop-in replacement of an AC motor (e.g., a PSC motor), such as in an HVACR system or other air mover system. Further, certain embodiments do not require extensive reconfiguration of the AC interface signals when replacing the AC motor with the DC motor system.

Certain embodiments include a motor, a motor drive circuit, and a plurality of outer terminals (which may be dedicated speed taps) connected to the motor drive circuit. The terminals may be configured to be selectively connected to an AC power supply to thereby select the motor speed (e.g., where a thermostat controls which outer terminals/speed taps are connected to the AC power supply). The motor may be a DC motor, such as an ECM. An interface circuit may be used to convert or translate high voltage AC signals to logic level signals (non-AC signals) that may be read by a digital device, such as a processor. For example, the interface circuit may detect which terminal is connected to the AC power supply, and output corresponding logic level signals. By way of further example, a logic level signal may be set to a first voltage level (e.g., in the range of 2V-5V, or in the range of the supply voltage to the supply voltage/2) to indicate a logic “1” and may be set to a second voltage level (e.g., in the range of 0V to 0.8V, or in the range of 0V to the supply voltage/2) to indicate a logic “0”. The interface circuit may also provide an electrical isolation function to protect sensitive digital circuits, such as a digital processor, from the AC signals.

The processor may control the DC motor based at least in part on the logic signals and a function. For example, the processor may output a pulse width modulated signal to control the speed of the DC motor.

An example embodiment provides a DC (direct current) motor system, comprising: a plurality of speed taps configured to be coupled to an AC (alternating current) power source; an interface circuit coupled to the plurality of speed taps, when the interface circuit is configured to: determine which speed taps of the plurality of speed taps are coupled to the AC power source, output one or more logic signals to indicate which speed taps of the plurality of speed taps are coupled to the AC power source, and provide electrical isolation to isolate one or more digital circuits from the AC power source; memory configured to store a value corresponding to an upper limit speed of a variable speed DC motor; a logic device coupled to the interface circuit, wherein the logic device is configured to: access the value corresponding to the upper limit speed of the variable speed DC motor from the memory, determine a commanded motor speed based at least in part on the one or more logic signals and the value corresponding to the upper limit speed, and output a pulse width modulated signal having a duty cycle corresponding to the determined commanded motor speed; a driver configured to receive the pulse width modulated signal and to output a corresponding signal; the variable speed DC motor, wherein the variable speed DC motor is configured to: receive the driver output signal, and rotate a rotor at a speed corresponding to the pulse width modulated signal duty cycle.

An example embodiment provides a method of operating a variable speed DC (direct current) motor, comprising: receiving at one or more of a plurality of speed taps a coupling to an AC (alternating current) power source; determining, via a circuit, which speed taps are coupled to the AC power source; outputting, from the circuit, one or more logic signals to indicate which speed taps of the plurality of speed taps are coupled to the AC power source; isolating one or more digital circuits from the AC power source; accessing a value corresponding to an upper limit speed of the variable speed DC motor; determining a commanded motor speed based at least in part on the one or more logic signals and the value corresponding to the upper limit speed; outputting a pulse width modulated signal having a duty cycle corresponding to the determined commanded motor speed; and rotating a rotor of the variable speed DC motor at a speed corresponding to the pulse width modulated signal duty cycle.

An example embodiment provides a method of replacing a variable speed AC motor having a first plurality of speed taps with a motor other than an AC motor, the method comprising: disconnecting one or more AC power conductors from the first plurality of speed taps of the variable speed AC motor; removing the variable speed AC motor from an air mover system; installing a variable speed DC motor system in place of the AC motor in the air mover system, wherein the DC motor system includes a second plurality of speed taps; and connecting the AC power conductors to the DC motor system via the second plurality of speed taps.

An example embodiment provides a method of replacing a variable speed AC motor having a first plurality of speed taps with a motor other than an AC motor, the method essentially consisting of: disconnecting one or more AC power conductors from the first plurality of speed taps of the variable speed AC motor; removing the variable speed AC motor from an air mover system; installing a variable speed DC motor system in place of the AC motor in the air mover system, wherein the DC motor system includes a second plurality of speed taps; and connecting the AC power conductors to the DC motor system via the second plurality of speed taps.

### BRIEF DESCRIPTION OF THE DRAWINGS

Embodiments of the present invention will now be described with reference to the drawings summarized below. These drawings and the associated description are provided to illustrate example embodiments of the invention, and not to limit the scope of the invention.

FIG. 1 illustrates a block diagram of an example motor system.

FIG. 2A illustrates a first example isolator/comparator circuit.

FIG. 2B illustrates a second example isolator/comparator circuit.

FIG. 3 illustrates an example processor and certain example interface.

FIG. 4 illustrates an example configuration and process.

FIG. 5 illustrates an example function that may be used to control motor speed.

FIG. 6 illustrates an example AC motor.

FIG. 7 illustrates a conventional DC motor.

FIG. 8 illustrates an example pulse width modulation for various motor speeds.

FIG. 9 illustrates an example process of retrofitting an AC motor with a DC motor system.

### DETAILED DESCRIPTION OF PREFERRED EMBODIMENTS

The disclosure provided herein describes example embodiments of methods and systems for selecting a speed of an electric motor (e.g., the rotational speed of the electric motor's rotor). By way of example, the motor may be a direct current (DC) motor, such as an ECM (Electronically Commutated Motor) that may be in the form of a programmable brushless DC motor including a permanent magnet rotor and an inverter.

Many conventional HVACR (Heating, Ventilating, Air Conditioning, and Refrigeration) systems utilize alternating current (AC) motors for air handlers and condensers. The use of AC motors in an HVACR application may result in a relatively inefficient operation. By contrast, an ECM typically uses less energy than an AC motor or PSC (permanent-split capacitor) motor such as are commonly used to move air in HVACR systems. The ECM may also offer more control over the motor speed than conventional AC motors, which is also beneficial in HVACR applications. However, conventional AC motors are powered and controlled using AC power, and therefore conventionally it has been not been possible to substitute such conventional AC motors via a drop in replacement DC motor.

A motor system in accordance with the embodiments discussed here advantageously enables the replacement of an installed AC motor, such as is frequently used in an HVAC system, with an efficient electrically commutated motor (ECM) or other DC motor. Further, certain optional embodiments enable an AC motor to be replaced with an ECM without changing the outer terminal wiring configuration. By way of example, certain embodiments provide a motor speed selecting feature without requiring the use of low voltage outer terminals/speed taps to provide for such motor speed selection. Thus, a DC motor system in accordance with certain embodiments disclosed herein may be wired to the same AC power wires/terminals that had been connected to the AC motor. This enables, for example, a blower in an HVACR system to use a DC motor to power a fan, where the blower previously utilized an AC motor to power the fan.

The designs, figures, and description herein are non-limiting examples of some embodiments of the invention. Other embodiments of the system may or may not include the features disclosed herein. Moreover, disclosed advantages and benefits may apply to only some embodiments, and should not be used to limit the scope of the invention.

As will be described herein, certain embodiments of a DC motor system includes an interface (e.g., an isolator/comparator) integrated with a DC motor, such as an ECM (optionally, where the isolator/comparator is included in the same housing or assembly as the ECM), to thereby enable the DC motor system to be used as a drop-in replacement for an AC motor. Thus, in certain embodiments, the interconnections to the speed control terminals of the DC motor system may be the same as that for the AC motor being replaced. Optionally, instead, the DC motor system may be used as the original motor in an air mover system, rather than as a drop-in replacement for an AC motor.

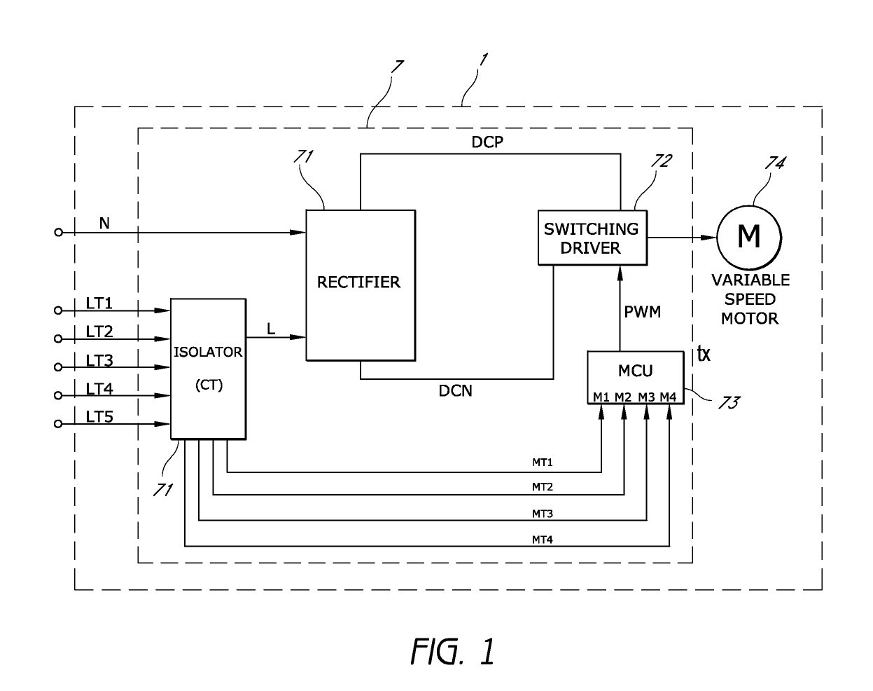

FIG. 1 illustrates a block diagram of an example motor system for use in a heating, ventilation, and air conditioning (“HVAC”) system. Optionally, all of the illustrated elements are integrated into the same housing or assembly, comparable in size to an AC motor being replaced with the example motor system. Thus, as discussed above, in certain embodiments the example motor system may be employed as a drop-in replacement for an existing AC motor.

Referring to FIG. 1, in the illustrated example embodiment, an HVAC motor system 1 has a variable speed motor 74 and a motor drive circuit 7 which provides speed selection of the motor 74. In some embodiments, the variable speed motor 74 is a DC motor. In an example embodiment, the motor 74 is a brushless DC motor (e.g., an electrically commutated brushless DC motor). In another embodiment, the motor 74 is a reluctant motor (a synchronous motor that induces non-permanent magnetic poles on a ferromagnetic rotor, generating torque via magnetic reluctance). The example motor driving circuit 7 includes a switching driver 72, a rectifier 71, a processor 73 (e.g., a microprocessor), an isolator/comparator circuit 70, and a power input unit.

The power input unit can be an AC power input unit configured to receive AC power/signals. The power input unit can include a plurality of power input terminals or taps N and LT1-LT5. In an example embodiment, the AC power supply having a high voltage (for example, a voltage between about 100 V and about 250 V) can be supplied via selected terminals from the terminals N and LT1-LT5. The terminals N and LT1-LT5 may optionally be connected to the same wiring/terminals as an AC motor being replaced (e.g., via individual wires, via a plug/socket arrangement, or otherwise). The input terminals may be coupled to the AC power supply in response to control signals from a thermostat (e.g., wherein the thermostat opens or closes relays between the AC power supply and the terminals N, LT1-LT-5, or otherwise).

The terminal N is connected to the rectifier 75, which may be a full bridge rectifier and which converts the AC power signal to a DC power signal. The terminals LT1-LT5 are connected to the rectifier 75 via the isolator/comparator circuit 70, which is configured to detect which tap of LT1-LT5 is energized and/or not energized. The speed selection can be carried out by connecting the AC power supply to one or more terminals among the terminals LT1-LT5 using relays, multiplexers, and/or other coupling devices. In the illustrated configuration, the terminal LT5 is provided for selecting the maximum speed of the motor, and LT1-LT4 are selected for selecting a speed less than the maximum speed.

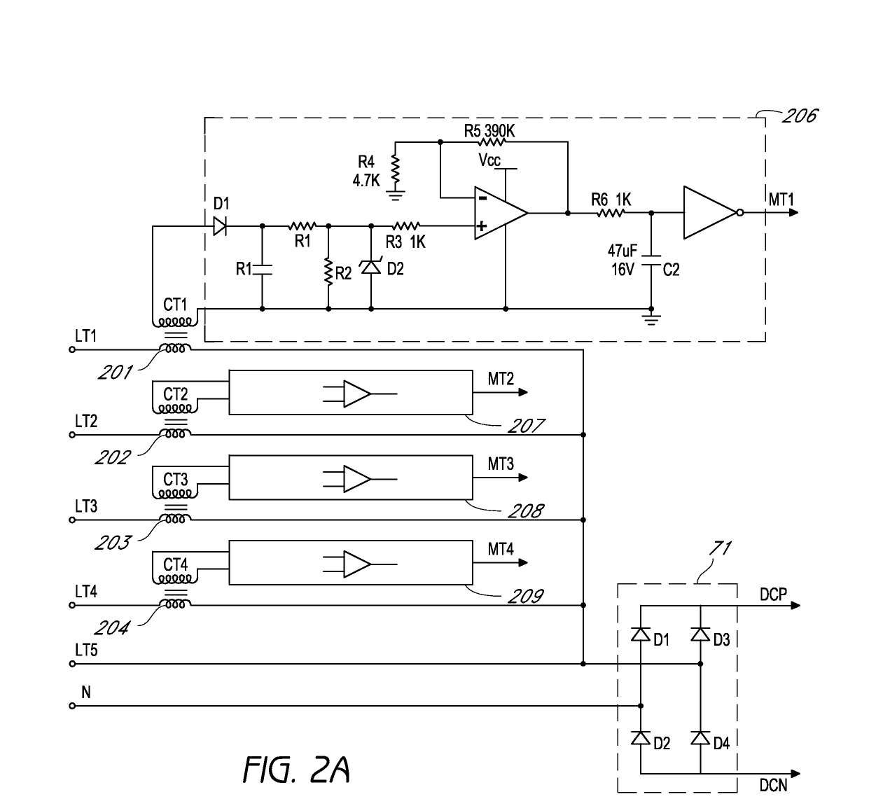

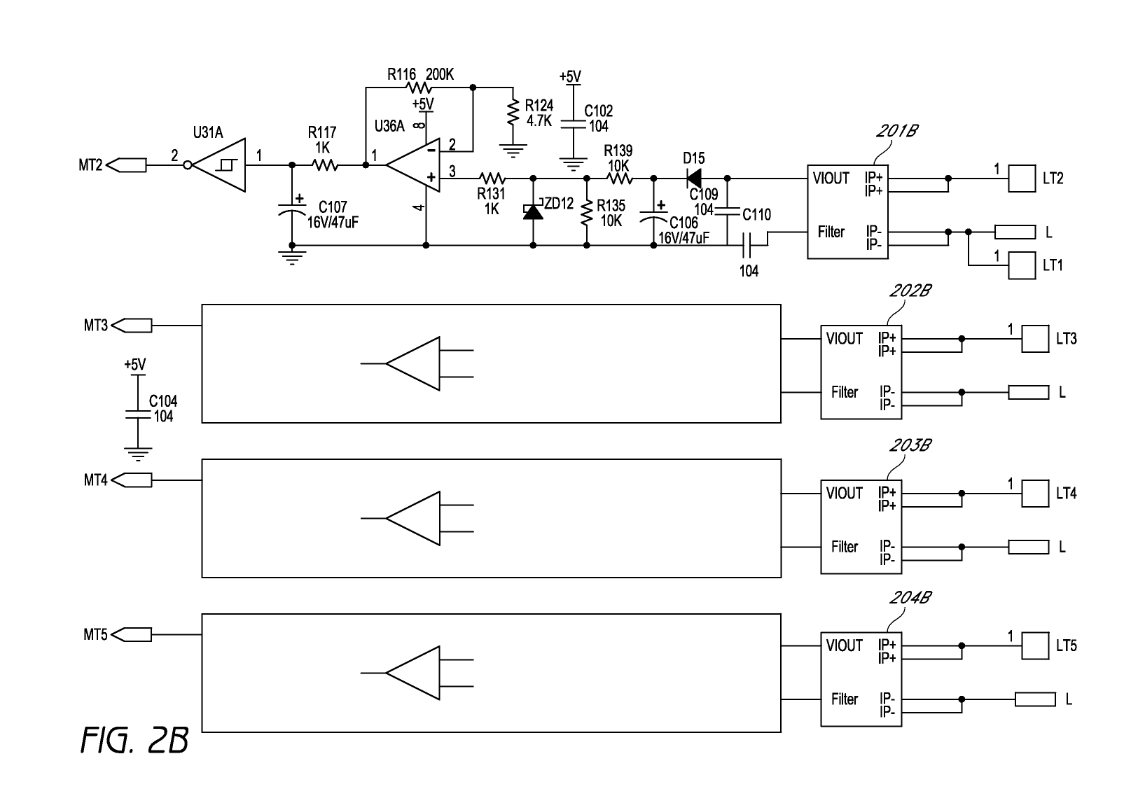

FIG. 2A illustrates an example configuration of the isolator/comparator circuit 70, which performs both an electrical isolation function (provides coupling with electrical isolation between its input and output, to prevent or reduce the high voltage AC inputs from damaging components on the other side), and converts high voltage AC signals to logic level signals. For example, a logic level signal may be at a first voltage level (e.g., in the range of 2V-5V, or in the range of the supply voltage to the supply voltage/2) to indicate a logic “1”, and may be at a second voltage level (e.g., in the range of 0V to 0.8V, or in the range of 0V to the supply voltage/2) to indicate a logic “0”. Thus, in an example embodiment, if a given tap is energized, the circuit 70 outputs first logic level (e.g., a logic “1”), and if a given tap is not energized, the circuit 70 outputs second logic level (e.g., a logic “1”).

Referring to FIG. 2A, in an example embodiment, the isolator/comparator circuit 70 includes transformers 201, 202, 203, 204 and current detecting circuits or comparator circuits (e.g., operational amplifier (op amp) comparator circuits) 206, 207, 208, 209, although fewer or additional current detecting and comparator circuits may be used.

One or more of the transformers 201-204 can be in the form of a current transformer, which can be used to measure current. In certain embodiments, the transformer 201 can be a micro-current transformer.

In a certain embodiment, the outer diameter of the micro current transformer can be smaller than about 20 mm, although other embodiments may utilize larger diameter transformers. In an example embodiment, the transformer 201 has a core, a primary winding and a secondary winding. To decrease the resistance of the power line between the terminal LT1 and the rectifier 71, optionally the primary winding has two or less turns, although more turns may be used. The secondary winding has a coil, optionally with a diameter of about 0.1 mm to about 0.2 mm, although larger or smaller diameter cores may be used. Optionally, the number of turns of the secondary winding can be about 15 to about 30 times of that of the primary winding, although the ratio can be greater or smaller. In one example embodiment, the number of turns of the secondary winding can be about 20 times of that of the primary winding.

Referring again to FIG. 2A, in the example illustrated embodiment, the terminal LT1 is connected to the primary winding of the transformer 201, which is connected to the rectifier 71. The current detecting circuit 206 is connected to the secondary winding of the transformer 201. Further, the terminal LT1 is connected to the rectifier 71. Similarly, the terminal LT2 is connected to the primary winding of the transformer 202 which is connected to the rectifier 71. The current detecting circuit 207 is connected to the secondary winding of the transformer 202.

The terminal LT3 is connected to the primary winding of the transformer 203, which is connected to the rectifier 71. The current detecting circuit 208 is connected to the secondary winding of the transformer 203. The terminal LT4 is connected to the primary winding of the transformer 204, which is connected to the rectifier 71. The current detecting circuit 209 is connected to the secondary winding of the transformer 204.

In an example embodiment, the terminal LT5 representing the maximum speed of the motor (e.g., the maximum desired speed of the motor, where it is possible that the motor can be operated at a higher speed, but it is undesirable to do so because, for example, it may affect system reliability) can be connected to the rectifier 71 without a transformer between the terminal LT5 and the rectifier 71.

In the illustrated example, each of the comparator circuits 206-209 outputs a signal to the processor 73, when a corresponding terminal among the terminals 201-204 is connected to the AC power supply. The comparator circuit 206 has a rectifying circuit for rectifying the voltage induced in the secondary winding of the transformer 201. In the illustrated embodiment, the rectifying circuit includes diodes D1, D2, a condenser C1 and resisters R1, R2, R3. The DC voltage from the rectifying circuit is connected to the (+) terminal of the op-amp. The (−) terminal of the op-amp is connected to the output terminal of the op-amp via a resister R5.

The output of the op-amp is connected to an integrator circuit having a resister R6 and a condenser C2. The output signal of the op-amp is transferred to a gate. The gate can be a logic gate, such as a Schmitt Trigger NOT gate (a NOT gate with hysteresis, where the output retains its value until the input changes sufficiently to trigger a change). The comparator circuit 206 outputs an H-L signal having a logic level to the microprocessor 73 via a line MT1. Optionally, some or all of the op-amp comparator circuits 207-209 have the same or substantially the same configuration and operation with those of the op-amp comparator circuit 206. The signal from respective op-amp comparator circuits 206-209 can be transmitted via the corresponding one of the lines MT1-MT4.

Referring to FIGS. 1 and 2A, the AC power supplied through the terminal N and one of the terminals LT1-LT5 is transmitted to the rectifier 71, and converted into a DC power in the rectifier 71. The DC power is supplied to the switching driver 72.

FIG. 2B illustrates another example configuration of the isolator/comparator circuit 70. In this example embodiment, rather than using transformers to measure current, a Hall effect sensor may used, which may, in certain circumstances be less expensive and/or smaller in size then the transformer discussed above with respect to FIG. 2A. The Hall effect sensors 201B, 202B, 203B, 204B may include linear Hall sensor circuit with a conduction path located near or on the surface of the sensor die. When current is sourced via the input taps and flows through the conduction path, a magnetic field is generated, which in turn is sensed by a Hall transducer, and converted into a proportional voltage. Other techniques may be used to sense current.

While the foregoing examples discuss methods and circuits for detecting which terminal is energized by detecting current, optionally instead or in addition, voltage may be detected by the motor system in order to determine which terminal is energized, that is, which is connect to the AC power source signal.

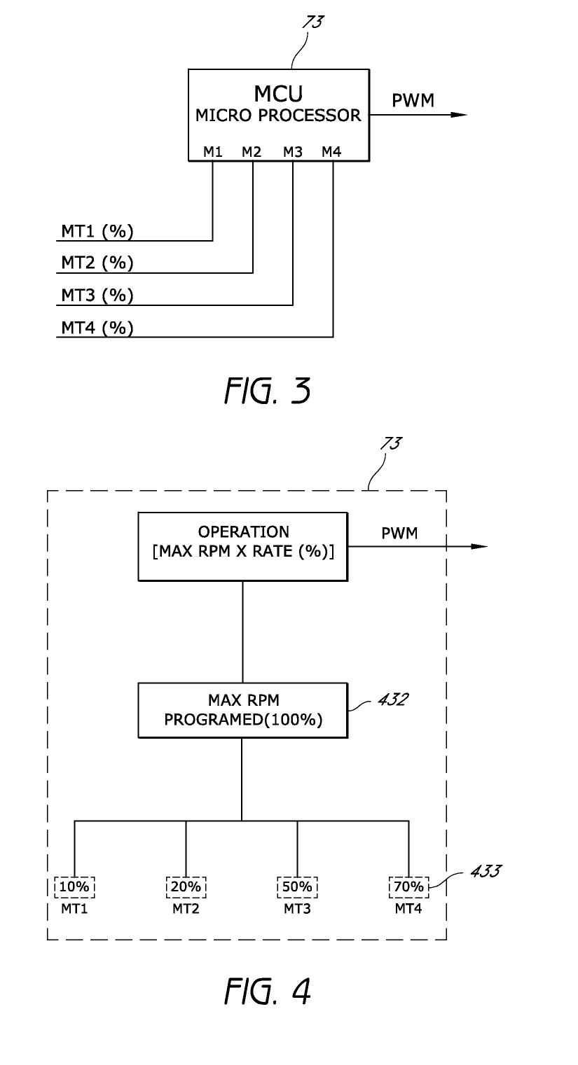

FIGS. 3-5 illustrate example configurations and operations of the processor 73. Referring to FIGS. 1 and 3, in an example embodiment, the processor 73 receives the logic level signals transferred from the isolator/comparator circuit 71 through lines MT1-MT4. In response to the received logic level signals, the processor 73 performs a calculation process to generate a PWM (Pulse Width Modulation) signal representing the selection of a motor speed, and outputs the PWM signal to the switching driver 72.

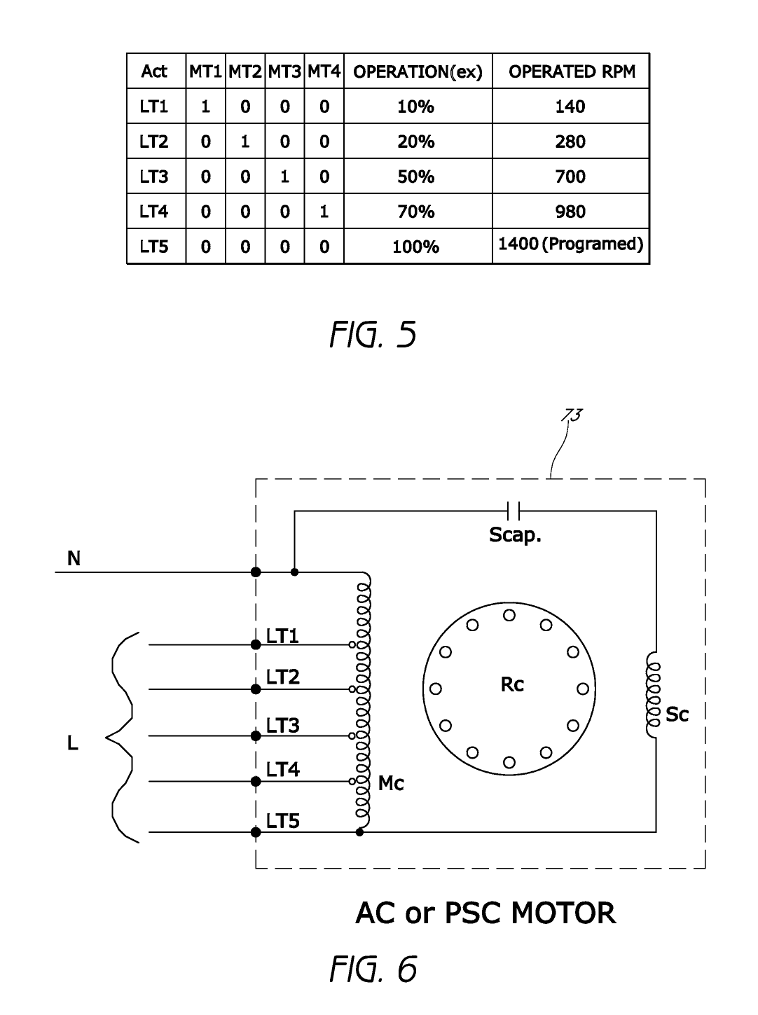

Referring to FIGS. 4 and 5, in some embodiments, the processor 73 stores motor speed data and a function 433 in memory. The motor speed data may include a constant value, such as an upper limit or maximum motor speed data 432, which specifies a maximum desirable revolutions/time period, such as revolutions per minute (RPM). The function 433 may include a mathematical equation, a logic equation, and/or a look-up table, that inputs motor speed command data, motor data, and optionally other data, and outputs motor speed control data.

In an example embodiment, the processor 73 accesses and executes software (e.g., firmware and/or other programmatic code) to compute a motor speed using the function 433, the maximum motor speed data 432, the logic level signals received from the isolator/comparator circuit 70, and/or other data. In this example, an operation 731, performed by the processor 73, generates a PWM signal at a duty cycle determined, at least in part, by multiplying the maximum acceptable motor speed by the specified percentage as determined by the function 433.

In a certain example embodiment illustrated in FIG. 5, the processor 73 computes a specific proportion of the maximum speed as a selected speed when a logic level signal from each of the comparator circuits 206-209 is at a certain level (e.g., a logic high level) as shown in FIG. 5. In an example, if the “maximum” motor speed of the motor rotor is 1400 rpm (revolution per minute), when the high voltage power line is connected to the terminal LT1, the selected speed is 140 rpm, which is 10% of the maximum speed, i.e., 1400 rpm. When the high voltage power line is connected to the terminal LT2, the selected speed is 280 rpm, which is 20% of the maximum speed of 1400 rpm. Similarly, when the high voltage power line is connected to the terminals LT3 and LT4, the selected speeds are respectively 700 rpm and 980, which are 50% and 70% of the maximum speed, 1400 rpm, respectively. When the high voltage power line is connected to the terminal LT5, the maximum motor speed, 1400 rpm, is selected.

In the embodiment illustrated in FIGS. 4 and 5, the function 733 is configured to compute 10%, 20%, 50% and 70% of the maximum speed, when the terminals LT1, LT2, LT3 and LT4 are selected, respectively. However, in another embodiment, the function 733 is configured to compute an alternative proportion of the maximum speed when each of the terminals LT1, LT2, LT3 and LT4 is selected. Further, in one embodiment, the function 733 can be a linear equation. In another embodiment, the function 733 can be a polynomial equation.

In the example embodiment illustrated in FIG. 5, the logic level signal from only one of the comparator circuits 206-209 has an “active” level (e.g., a high level) at a time. Alternatively, the signals from two or more of the comparator circuits 206-209 can have a high level at the same time at two terminals. For example, when both LT1 and LT2 are connected, the signals from the circuits 206 and 207 have a high level. In this alternative embodiment, the combination of the signals from the circuits 206 and 207 can be one of 00, 01, 10 and 11. Thus, four speeds can be selected using two terminals LT1-LT2. Similarly, 9 speeds can be selected using three terminals, for example LT1-LT3. Thus, the number of speeds can be (the number of terminals)². Other embodiments can utilize still other or additional signal codings for speed commands. In certain embodiments, the processor 73 is programmable so that the maximum speed 732 and the function 733 can be changed by a user (e.g., via an interface hosted by a device, such as a personal computer or dedicated controller, coupled to the processor 73 and/or processor memory).

Referring back to FIGS. 1 and 4, the PWM signal generated using the processor 73 is transmitted to the switching driver 72. The switching driver 72 controls the current or power supplied to the motor 74 using the PWM signal generated using the processor 73 such that the motor is operated at a selected speed.

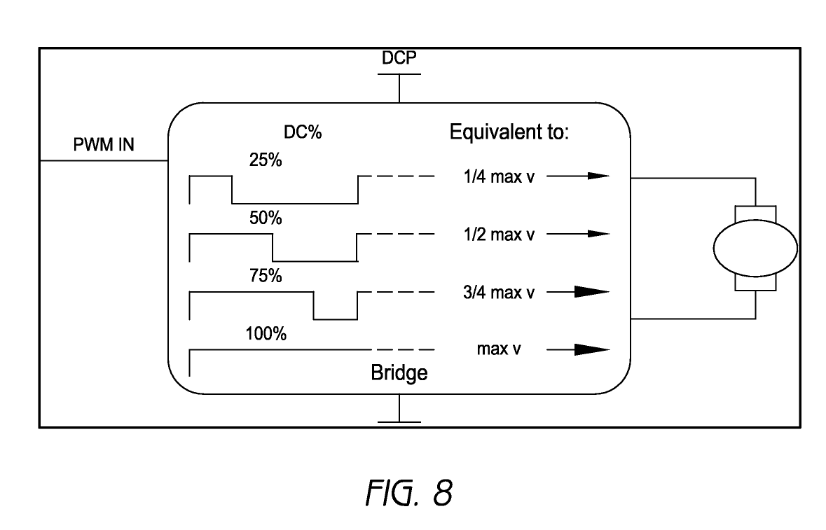

FIG. 8 illustrates an example correspondence of a PWM signal to an average output voltage, where the speed of the DC motor is proportional or related to the applied average voltage. In this example, if the PWM is at a 25% duty cycle, then the output to the DC motor is about ¼ of the maximum output voltage (where, for example, the maximum output voltage is optionally 12V or 24V). If the PWM is at a 50% duty cycle, then the output to the DC motor is about ½ of the maximum output voltage. If the PWM is at a 75% duty cycle, then the output to the DC motor is about ¾ of the maximum output voltage. If the PWM is at a 100% duty cycle, then the output to the DC motor is about equal of the maximum output voltage.

Thus, the motor system in accordance with the embodiments discussed above enables the replacement of an AC motor that is typically used in an HVAC system with a highly efficient electrically commutated motor (“ECM”), optionally as a drop-in replacement. For example, the motor system 1 having the ECM illustrated in FIG. 1 can replace an AC motor illustrated in FIG. 6. Referring to FIG. 6, in an example legacy HVAC system, an AC motor or PSC motor is used. The motor configuration illustrated in FIG. 6 has plural winding taps LT1-LT5 for selecting a motor speed. The apparatus and ECM shown in FIG. 1 (which is optionally packaged as a single, integrated unit) can replace the AC motor shown in FIG. 6 (where the AC or PSC motor is removed and no longer in the air mover) without changing the outer terminal configuration.

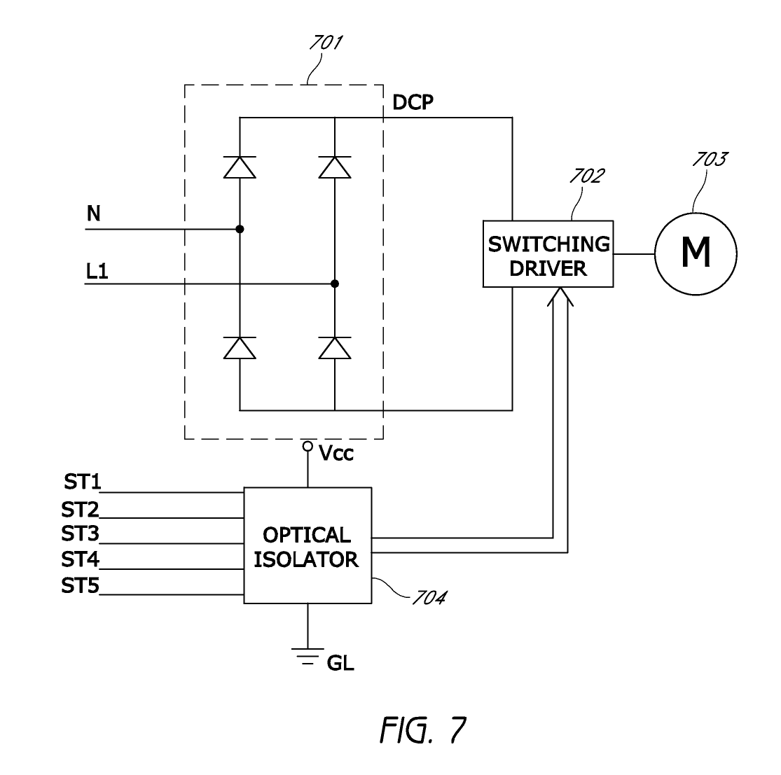

By contrast, conventionally, in order to employ an ECM to replace a PSC motor, the outer terminal configuration would need to be changed. For example, referring to FIG. 7, conventionally in addition to AC power lines N and L1 (connected to rectifier 701) the motor system, including ECM 703, requires low voltage terminals ST1-ST5 to be connected to a electric power source having a low voltage (for example, a voltage in the range of 12 to 24 V) to provide a motor speed selecting feature (where the signals are coupled from the low voltage terminals to the switching driver 702, via isolator 704). However, the motor system in accordance with certain of the above embodiments does not require low voltage interface terminals for selecting a motor speed.

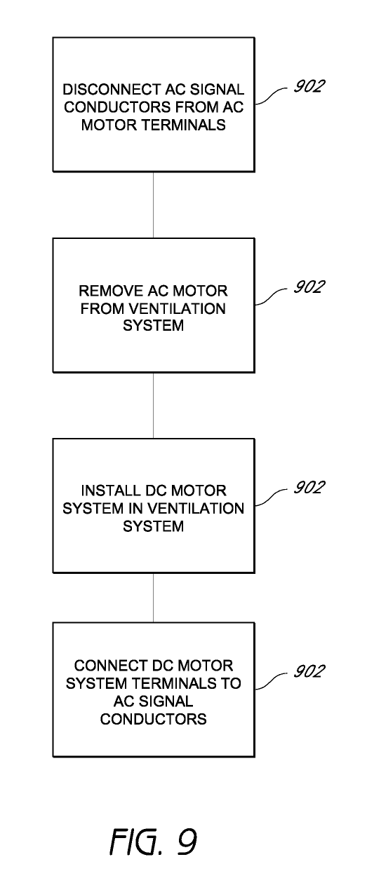

FIG. 9 illustrates an example process for replacing an AC motor with a DC motor system, examples of which have been described above. At state 902, a user (e.g., an HVACR installer) disconnects the AC signal conductors from the terminals (which may be in the form of a plug/socket) of an AC motor. At state 904, the user removes the AC motor from the ventilation unit (e.g., a blower or other air mover), such as by unbolting the AC motor. At state 906, the user installs/mounts the DC motor system into the ventilation unit, in place of the AC motor (e.g., bolts the DC motor system into the ventilation unit). At state 908, the user connects the DC motor to the same signal conductors that had been previously coupled to the AC motor. Optionally, the DC motor has the same number of speed taps as the AC motor being replaced. The operator may then turn on the HVAC system and set the thermostat, as desired. It is understood that the foregoing process does not have to performed in the order described above. For example, the DC motor may be connected to the signal conductors prior to it being mounted in the ventilation unit.

Thus, as discussed herein, certain embodiments include a motor system for use in a ventilation system (e.g., to drive a blower fan) that comprises a motor (e.g., an ECM), a motor drive circuit; and a plurality of outer terminals connected to the motor drive circuit. The terminals are configured to be selectively connected to an AC power supply (e.g., under the control of a thermostat) to thereby select the motor speed.

In certain embodiments, the motor drive circuit comprises a first transformer comprising a primary winding connected to a first one of the plurality of outer terminals and a secondary winding.

In certain embodiments, the motor drive circuit also comprises a first signal generating circuit connected to the secondary winding of the first transformer. The first signal generating circuit is configured to generate a signal representing connection or disconnection between the first terminal and the AC power supply.

The motor drive circuit also comprises a second transformer comprising a primary winding connected to a second one of the plurality of outer terminals and a secondary winding. In this example, a second signal generating circuit is connected to the secondary winding of the second transformer and is configured to generate a signal representing connection or disconnection between the first terminal and the AC power supply.

The systems and methods disclosed herein can be implemented in hardware, software, firmware, or a combination thereof. Software can include computer readable instructions stored in memory (e.g., non-transitory, tangible memory, such as solid state memory (e.g., ROM, EEPROM, FLASH, RAM), optical memory (e.g., a CD, DVD, Bluray disc, etc.), magnetic memory (e.g., a hard disc drive), etc., configured to implement the algorithms on a general purpose computer, special purpose processors, or combinations thereof. For example, one or more computing devices, such as a processor, may execute program instructions stored in computer readable memory to carry out processed disclosed herein. Hardware may include state machines, one or more general purpose computers, and/or one or more special purpose processors.

While certain embodiments may be illustrated or discussed as having certain example components, additional, fewer, or different components may be used. Further, with respect to the processes discussed herein, various states may be performed in a different order, not all states are required to be reached, and fewer, additional, or different states may be utilized.

Conditional language, such as, among others, “can,” “could,” “might,” or “may,” unless specifically stated otherwise, or otherwise understood with the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features elements, and/or steps are included or are performed in any particular embodiment.

Any process descriptions, elements, or blocks in the flow diagrams described herein, and/or depicted in the attached figures, should be understood as potentially representing modules, segments, or portions of code which include one or more executable instructions for implementing specific logical functions or steps in the process. Implementations are included within the scope of the embodiments described herein which elements or functions which may be deleted, depending on the functionality involved, as would be understood by those skilled in the art.

Although this invention has been described in terms of certain preferred embodiments, other embodiments that are apparent to those of ordinary skill in the art, including embodiments that do not provide all of the features and advantages set forth herein, are also within the scope of this invention.

What is claimed is:

1. A DC (direct current) motor system, comprising:
a plurality of speed taps configured to be coupled to an AC (alternating current) power source;
an interface circuit coupled to the plurality of speed taps, when the interface circuit is configured to:
determine which speed taps of the plurality of speed taps are coupled to the AC power source,
output one or more logic signals to indicate which speed taps of the plurality of speed taps are coupled to the AC power source, and
provide electrical isolation to isolate one or more digital circuits from the AC power source;
memory configured to store a value corresponding to an upper limit speed of a variable speed DC motor;
a logic device coupled to the interface circuit, wherein the logic device is configured to:
access the value corresponding to the upper limit speed of the variable speed DC motor from the memory,
determine a commanded motor speed based at least in part on the one or more logic signals and the value corresponding to the upper limit speed, and
output a pulse width modulated signal having a duty cycle corresponding to the determined commanded motor speed;
a driver configured to receive the pulse width modulated signal and to output a corresponding signal;
the variable speed DC motor, wherein the variable speed DC motor is configured to:
receive the driver output signal, and
rotate a rotor at a speed corresponding to the pulse width modulated signal duty cycle.

2. The DC motor system as defined in claim 1, wherein the DC motor system is configured to be a drop-in replacement for a first AC motor having a first set of input terminals, and the DC motor system includes a second set of input terminals having the same configuration as the first set of input terminals.

3. The DC motor system as defined in claim 1, wherein the speed taps, interface circuit, memory, logic device, driver, and variable speed DC motor are housed together so as to be installed in an air mover system as a single unit.

4. The DC motor system as defined in claim 1, wherein the variable speed DC motor comprises an electronically commutated motor.

5. The DC motor system as defined in claim 1, wherein the variable speed DC motor comprises a reluctance motor.

6. The DC motor system as defined in claim 1, wherein the interface circuit includes a current sensing circuit.

7. The DC motor system as defined in claim 1, wherein the interface circuit includes a current sensing circuit including a transformer.

8. The DC motor system as defined in claim 1, wherein the interface circuit includes a current sensing circuit including a sensor that detects magnetic fields.

9. The DC motor system as defined in claim 1, wherein the logic device comprises a digital processor.

10. A method of operating a variable speed DC (direct current) motor, comprising:
receiving at one or more of a plurality of speed taps a coupling to an AC (alternating current) power source;
determining, via a circuit, which speed taps are coupled to the AC power source;
outputting, from the circuit, one or more logic signals to indicate which speed taps of the plurality of speed taps are coupled to the AC power source;
isolating one or more digital circuits from the AC power source;
accessing a value corresponding to an upper limit speed of the variable speed DC motor;
determining a commanded motor speed based at least in part on the one or more logic signals and the value corresponding to the upper limit speed;
outputting a pulse width modulated signal having a duty cycle corresponding to the determined commanded motor speed; and
rotating a rotor of the variable speed DC motor at a speed corresponding to the pulse width modulated signal duty cycle.

11. The method as defined in claim 10, wherein the variable speed DC motor comprises an electronically commutated motor.

12. The method as defined in claim 10, wherein the variable speed DC motor comprises a reluctance motor.

13. The method as defined in claim 10, wherein determining which speed taps are coupled to the AC power source further comprises sensing a current with respect to one or more of the plurality of speed taps.

14. The method as defined in claim 13, wherein sensing the current further comprises sensing the current using a current sensing circuit including a transformer.

15. The method as defined in claim 13, wherein sensing the current further comprises sensing the current using a current sensing circuit including a sensor that detects magnetic fields.

16. A method of replacing a variable speed AC motor having a first plurality of speed taps with a motor other than an AC motor, the method comprising:
disconnecting one or more AC power conductors from the first plurality of speed taps of the variable speed AC motor;
removing the variable speed AC motor from an air mover system;
installing a variable speed DC motor system in place of the AC motor in the air mover system,
wherein the DC motor system includes a second plurality of speed taps; and
connecting the AC power conductors to the DC motor system via the second plurality of speed taps.

17. The method as defined in claim 16, where the AC motor has a first set of input terminals, and the DC motor system includes a second set of input terminals having the same configuration as the first set of input terminals.

18. The method as defined in claim 16, where the DC motor system includes the second plurality of speed taps, an interface circuit coupled to the speed taps, memory storing an upper speed limit value, a digital device configured to generate a pulse width modulated signal having a duty cycle based at least in part on which speed taps in the second plurality of speed taps are connected to AC power, and the variable speed DC motor configured to rotate at a speed corresponding to the duty cycle, and wherein the speed taps, interface circuit, memory, digital device, and variable speed DC motor are housed together so as to be installed in the air mover system as a single unit.

19. The method as defined in claim 16, where the DC motor system includes an electronically commutated motor or a reluctance motor.

20. The method as defined in claim 16, the method further comprising sensing a current with respect to one or more speed taps of the second plurality of speed taps in order to determine which of the second plurality of speed taps is energized.

21. The method as defined in claim 16, the method further comprising:
determining which of the second plurality of speed taps is energized by an AC power source;
outputting one or more logic level signals based at least in part on the determination as to which of the second plurality of speed taps are energized by the AC power source;
generating a pulse width modulated signal having a duty cycle set based at least in part on the one or more logic level signals; and
causing a rotor of the DC motor system to rotate at a speed corresponding to the duty cycle.
